(19) United States
(12) Patent Application Publication
(10) Pub. No.: US 2016/0036321 A1
(43) Pub. Date: Feb. 4, 2016

(54) DYNAMIC BYPASS CAPACITANCE

(71) Applicant: QUALCOMM Incorporated, San Diego, CA (US)

(72) Inventors: Tauseef Kazi, San Diego, CA (US); Rashmi Kulkarni, San Carlos, CA (US)

(21) Appl. No.: 14/446,144

(22) Filed: Jul. 29, 2014

(51) Int. Cl. H02M 3/156; H04M 1/73; G05F 1/56

(52) U.S. Cl. CPC H02M 3/156; G05F 1/56; H04M 1/73

(57) ABSTRACT

A dynamic bypass capacitance is provided for a power rail. The dynamic bypass capacitance equals a first bypass capacitance during an idle mode for a digital core powered by the power rail. During an active mode for the digital core, the dynamic bypass capacitance equals a second bypass capacitance that is greater than the first bypass capacitance.

### TECHNICAL FIELD

This application relates to bypass capacitors, and more particularly to a dynamic bypass capacitor.

### BACKGROUND

A digital circuit such as a microprocessor or a system-on-a-chip (SOC) includes numerous transistors that alternate between dormant and switching states. The digital circuits are powered by power rails supplying power supply voltages maintained by corresponding regulators. The regulators function to maintain the power supply voltages on the power rails. But digital circuits may make abrupt current demands when a large number of transistors switch states. The power supply voltage provided by a power rail may then sag unacceptably despite the action of its regulator in promoting a stable power supply voltage.

To keep the power supply voltages from dipping unacceptably, the power rails may be tied to decoupling capacitors that provide additional power to the digital circuits when needed and may recharge at a later time when power demand subsides. A decoupling capacitor, unlike a conventional regulator, can supply the instantaneous current demands when numerous transistors suddenly change state and conduct current. In this sense, the decoupling capacitor decouples the power supply from the abrupt power demands made by the digital circuits. A decoupling capacitor may also be denoted as a bypass capacitor since the device receiving instantaneous power from a bypass capacitor is bypassing the primary power source (a battery driving a power regulator that in turn drives the power rail coupled to the bypass capacitor).

Although bypass capacitors are routinely provided for modern integrated circuits, their use may aggravate power demands. In particular, it is conventional for an SOC to include various power domains that may be powered down independently during idle or standby modes of operation. The collapsing of a power rail for a particular power domain wastes the charge stored in the corresponding bypass capacitor. This power consumption issue may be better appreciated with reference to FIG. 1, which show a conventional system 100 including a bypass capacitor 120 coupled to a power rail 125 that powers a power domain in an SOC 101 such as a digital core 105. A power regulator 110 converts a battery voltage from a battery 115 into a power supply voltage VDD that charges power rail 125. To save power, digital core 105 will typically be configured to operate in an idle or sleep mode when not being used. In such an idle mode, power regulator 110 either shuts off to allow the power supply voltage VDD to collapse (discharge) or continues to operate at a reduced rate to allow the power supply voltage VDD to decrease to a reduced level during the idle mode. During an active mode of operation for digital core 105, power regulator 110 restores the power supply voltage VDD to its operating level. Bypass capacitor 120 is then charged to this increased level for power supply voltage VDD. When digital core 105 again switches into the idle mode of operation, the resulting charge on bypass capacitor 120 must either be discarded entirely (should power supply voltage VDD be collapsed) or partially discharged if a reduced level for power supply voltage VDD is maintained during the idle mode of operation. Battery 115 must then supply this lost charge to bypass capacitor 120 when it is again recharged to the operating level for power supply voltage VDD. This current drain on battery 115 reduces its operating time.

Accordingly, there is a need in the art for improved power management techniques with regard to the use of bypass capacitors.

### SUMMARY

A dynamic bypass capacitor is provided having a bypass capacitance that increases during an active mode for a digital core and decreases during an idle mode for the digital core.

These and other advantageous features may be better appreciated through the following detailed description.

### BRIEF DESCRIPTION OF THE DRAWINGS

FIG. 1 is a diagram of a conventional system including a bypass capacitor.

FIG. 2 is a diagram of a system incorporating a dynamic bypass capacitor in accordance with an embodiment of the disclosure.

FIG. 3 is a flowchart for a power management method using a dynamic bypass capacitor in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

To prevent the conventional waste of charge from a bypass capacitor when the corresponding power rail is collapsed (discharged to ground), a dynamic bypass capacitor is provided. The dynamic bypass capacitor stores a first amount of charge during an active mode of operation when the corresponding power rail is powered. The dynamic bypass capacitor stores a second amount of charge during an idle mode of operation when the corresponding power rail is discharged. The second amount of charge is less than the first amount. In this fashion, the dynamic bypass capacitor stores more charge during the active mode and less charge during the idle mode. Although some charge must be discharged to ground when the dynamic bypass capacitor switches to the idle state, the remaining charge is preserved, thereby markedly increasing battery life (for battery-powered embodiments) and reducing power demands accordingly.

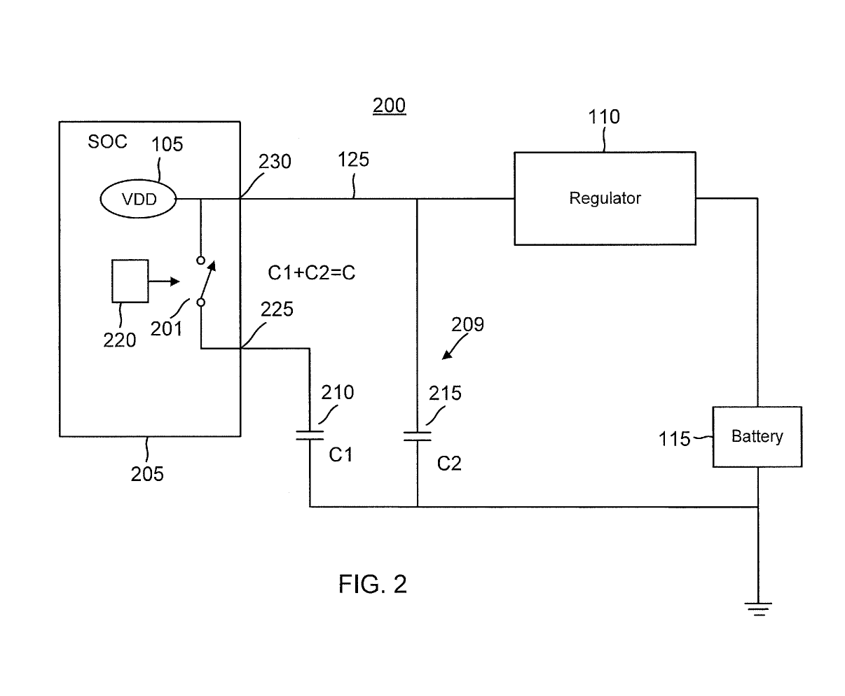

An example system 200 is shown in FIG. 2. A dynamic bypass capacitor 209 comprises a first bypass capacitor 210, a second bypass capacitor 215, and a switch 201. Second bypass capacitor 215 is permanently coupled to a power rail 125 that powers a power domain 105 in an integrated circuit such as a system-on-a-chip (SOC) 205. In system 200, bypass capacitors 210 and 215 are external to SOC 205. For example, bypass capacitors 210 and 215 may be implemented as discrete capacitors on the printed circuit board or package substrate (not illustrated) containing SOC 205. Alternatively, bypass capacitors 210 and 215 may be embedded within the package substrate for SOC 205. In one embodiment, bypass capacitors 210 and 215 may comprise multi-layer ceramic capacitors. Such discrete capacitors are advantageous in that they may be readily constructed to have an appreciable amount of capacitance so as to adequately function as bypass capacitors and satisfy the instantaneous current demands from SOC 205. However, the required capacitance for a bypass capacitor typically diminishes as the SOC clocking frequency increases. It will thus be appreciated that bypass capacitors 210 and 215 may be integrated within SOC 205 in alternative embodiments.

First bypass capacitor 210 couples to power rail 125 through switch 201, which is controlled by a power management circuit 220. First bypass capacitor 210 couples to a first input port 225 for SOC 205 that in turn couples to switch 201. Power rail 125 couples to a second input port 230 for SOC 205 that in turn couples to second bypass capacitor 215 and to a power regulator 110. Power regulator 110 is configured to charge power rail 125. Power regulator 110 thus charges first bypass capacitor 210 only when switch 201 is closed. In one embodiment, power domain 105 comprises a digital core 105 such as a microprocessor core. Power management circuit 220 controls switch 201 to open or close depending upon an operating mode for digital core 105. For example, digital core 105 may be configured to operate in an idle mode of operation or in an active mode of operation. Should SOC 205 comprise a cellular telephone SOC, the active mode of operation may correspond to a wakeup period within a discontinuous receive (DRX) cycle in which SOC 205 would then check for messages or calls. In such an embodiment, the idle mode would then correspond to the inactive period during the remainder of the DRX cycle.

In one embodiment, dynamic capacitor 209 may be deemed to comprise a means for loading a power rail with a first bypass capacitance during an idle mode for a digital core and for loading the power rail with a second bypass capacitance during an active mode for the digital core, wherein the second bypass capacitance is greater than the first bypass capacitance.

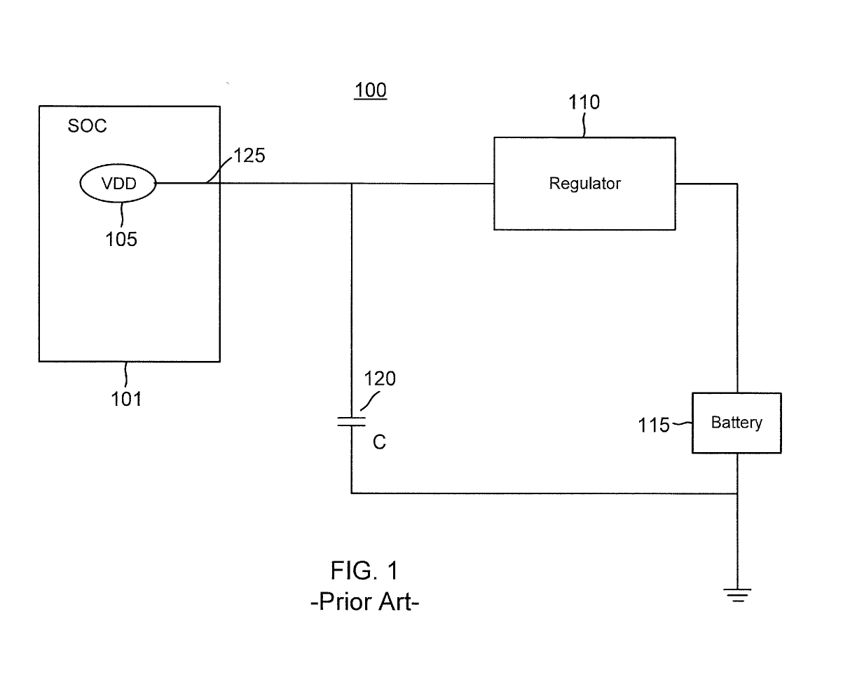

During a transition from an idle mode into an active mode, power management circuit 220 may command power regulator 110 to raise the power supply voltage VDD on power rail 125 to an operating level. Alternatively, power regulator 110 may be part of a power management integrated circuit (PMIC) (not illustrated) that would command power regulator 110 to increase power supply voltage VDD to the operating level. Second bypass capacitor 215 would then be charged by this increased level for the power supply voltage VDD. In conjunction with this transition, power management circuit 220 controls switch 201 to close so that first bypass capacitor 210 is also coupled to power rail 125. Since first bypass capacitor 210 was already charged to this increased level in a previous active mode before floating during the subsequent idle mode, first bypass capacitor 210 need not be recharged as compared to second bypass capacitor 215. Referring back to FIG. 1, a capacitance C for the original bypass capacitor 120 is sufficient to accommodate the expected instantaneous current demands as a function of time (di/dt) from digital core 105. Referring again to FIG. 2, a sum of a capacitance C1 for first bypass capacitor 210 and a capacitance C2 for second bypass capacitor 215 may equal C such that the sum of C1 and C2 is sufficient to accommodate the expected di/dt instantaneous current demands by digital core 105 in the active mode.

Digital core 105 will eventually transition from the active mode to the idle mode. Power management circuit 220 then commands switch 201 to open to decouple first bypass capacitor 210 from power rail 125. In addition, power management circuit 220 and/or a corresponding PMIC controls power regulator 110 to lower the power supply voltage VDD on power rail 125 to an idle mode level that is lower than the operating level used during the active mode. Some charge on second bypass capacitor 215 is then discharged to accommodate this lower voltage on power rail 125 during the idle mode. However, all the charge stored on first bypass capacitor 210 during the active mode is retained in the idle mode (absent any leakage) because first bypass capacitor 210 floats during the idle mode due to the decoupling from power rail 125 by opened switch 201.

The capacitance C2 for second bypass capacitor 215 may be sufficient to accommodate the expected instantaneous current demand by digital core 105 during the idle mode of operation. In such an embodiment, the capacitance C1 for first bypass capacitor 210 may then equal C minus C1, where C is the capacitance sufficient to accommodate the expected instantaneous current demand by digital core 105 during the active mode operation. In one embodiment, capacitance C1 may equal capacitance C2.

It will be appreciated that numerous alternative embodiments may be made to system 200. For example, if power rail 125 may be collapsed (discharged) during the idle mode, then there would be no need for second bypass capacitor 215. In such an embodiment, a capacitance C1 for first bypass capacitor 210 would then equal C, the bypass capacitance for the active mode of operation. In addition, switch 201 may be implemented by a transistor (or transistors) such as a PMOS or NMOS transistor having its gate driven by power management circuit 220. Power regulator 110 may comprise a linear dropout regulator or a switching regulator such as a buck converter. An example method of power management using a dynamic bypass capacitor will now be discussed.

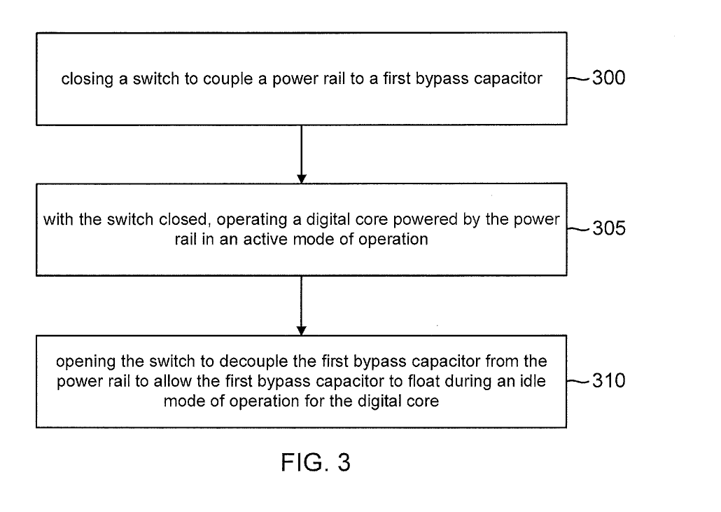

FIG. 3 is a flowchart for an example method of operation. The method includes an act 300 of closing a switch to couple a power rail to a first bypass capacitor. The closing of switch 201 in system 200 is an example of such an act. The method also includes an act 305 of, with the switch closed, operating a digital core powered by the power rail in an active mode of operation. The active mode of operation for digital core 105 in system 200 is an example of such an act. Finally, the method also includes an act 310 of opening the switch to decouple the first bypass capacitor from the power rail to allow the first bypass capacitor to float during an idle mode of operation for the digital core. The opening of switch 201 in system 200 is an example of such an act.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

We claim:

1. A system, comprising
a digital core;
a power rail configured to provide a power supply voltage to the digital core;
a first input port configured to receive power from a first bypass capacitor;
a switch coupled between the first input port and the power rail; and
a power management circuit configured to close the first switch when the digital core is an active mode of operation and to open the first switch when the digital core is in an idle mode of operation to allow the first bypass capacitor to float during the idle mode of operation.

2. The system of claim 1, wherein the switch comprises a transistor.

3. The system of claim 1, further comprising a second input port and a second bypass capacitor coupled to the second input port, wherein the power rail is coupled to the second bypass capacitor through the second input port.

4. The system of claim 3, wherein the digital core, the power rail, the first input port, the second input port, and the power management circuit are all incorporated into a system-on-a-chip (SOC), the system further comprising:
a power regulator configured to drive the second input port with the power supply voltage.

5. The system of claim 4, wherein the SOC is a cellular telephone SOC, and wherein the idle mode is an idle mode during a DRX cycle for the cellular telephone SOC.

6. The system of claim 4, further comprising a battery configured to provide power to the power regulator.

7. The system of claim 4, wherein the power regulator is a linear dropout power regulator.

8. The system of claim 4, wherein the power management circuit is further configured to control the power regulator to charge the power supply voltage to a first level during the active mode and to a second level during the idle mode, wherein the first level is greater than the second level.

9. The system of claim 4, further comprising a power management integrated circuit that includes the power regulator.

10. The system of claim 3, wherein the first bypass capacitor has a capacitance that substantially equals a capacitance of the second bypass capacitor.

11. The system of claim 1, wherein the digital core is a microprocessor core.

12. The system of claim 3, wherein a sum of a capacitance for the first bypass capacitor and a capacitance for the second bypass capacitor equals a capacitance sufficient to supply an expected instantaneous current demand by the digital core in the active mode of operation.

13. The system of claim 12, wherein the capacitance for the second bypass capacitor is sufficient to supply an expected instantaneous current demand by the digital core in the idle mode of operation.

14. A method, comprising:
closing a switch to couple a power rail to a first bypass capacitor;
with the switch closed, operating a digital core powered by the power rail in an active mode of operation; and
opening the switch to decouple the first bypass capacitor from the power rail to allow the first bypass capacitor to float during an idle mode of operation for the digital core.

15. The method of claim 14, further comprising:
while the switch is closed, charging the power rail to a first power supply voltage level.

16. The method of claim 15, further comprising:
while the switch is open, charging the power rail to a second power supply voltage level that is lower than the first power supply voltage level and stabilizing the charged power rail with a second bypass capacitor.

17. The method of claim 14, wherein closing the switch comprises driving a gate of a transistor to cause the transistor to conduct to couple the first bypass capacitor to the power rail.

18. The method of claim 14, further comprising discharging the power rail while the switch is open.

19. A system, comprising:
a digital core;
a power rail configured to provide a power supply voltage to the digital core; and
means for loading the power rail with a first bypass capacitance during an idle mode for the digital core and for loading the power rail with a second bypass capacitance during an active mode for the digital core, wherein the second bypass capacitance is greater than the first bypass capacitance.

20. The system of claim 19, wherein the digital core is a microprocessor core.
